(19) United States
(12) Patent Application Publication
(10) Pub. No.: US 2014/0271067 A1
(43) Pub. Date: Sep. 18, 2014

(54) END FITTING ASSEMBLY FOR CHAIN HOIST

(71) Applicant: Ventra Group, Inc., Bradford (CA)

(72) Inventors: Tim G. ROSSI, Bolton (CA); Terry C. HU, Markham (CA)

(73) Assignee: Ventra Group, Inc., Bradford (CA)

(21) Appl. No.: 14/214,100

(22) Filed: Mar. 14, 2014

Related U.S. Application Data
(60) Provisional application No. 61/794,496, filed on Mar. 15, 2013.
(60) Provisional application No. 61/804,493, filed on Mar. 22, 2013.

(51) Int. Cl. F16M 13/02; B62D 43/04; B23P 11/00; B62D 43/00

(52) U.S. Cl. CPC F16M 13/02; B62D 43/002; B62D 43/045; B23P 11/00
USPC 414/463; 248/205.1; 29/505

(57) ABSTRACT

An end fitting for a chain hoist with a drive chain. The end fitting is configured to receive and absorb forces transferred from the spare tire to the chain as well as maintain the structural integrity of the last chain link of the drive chain and prevent disassembly. The end fitting is formed from a link insert, whose body is inserted into a last link of the drive chain, and a support bracket. The body of the link insert is inserted partially through and surrounded by the last link of the drive chain, and the bracket, which at least partially surrounds both of the body of the link insert and the last link, prevents disassembly. The body of the link insert and the support bracket can be correspondingly shaped such that the link insert is substantially aligned with and against the support bracket.

### CROSS REFERENCE TO RELATED APPLICATIONS

This application is related to and claims priority to U.S. Provisional Patent Application Ser. No. 61/794,496, filed Mar. 15, 2013, and U.S. Provisional Patent Application Ser. No. 61/804,493, filed Oct. 15, 2012, both of which are hereby incorporated by reference herein in their entirety.

### BACKGROUND

1. Field

The present disclosure is generally related to an end fitting assembly for use with a chain hoist. The hoist can be used in a spare tire carrier.

2. Description of Related Art

Chain hoists use a drive chain as the lifting device to support weight of a load (e.g., spare tire). One end of the chain is connected within a housing of the reel assembly while another extends outside of the housing and is connected to an end piece, so that the load can be attached to the chain via an attachment device connected thereto. One prior method uses a steel rod with pierced eyelet hole at the end of the chain. This requires the last chain link to be open (or opened by a worker) so that the open link can be inserted into the eyelet hole, and then crimped closed and welded together. Welding of the link changes the mechanical properties of the link material (e.g., steel), requires precise welding methods, and generally creates a failure point (i.e., “weak link”).

Another method uses parts that loosely connect together without welding. Although the assembly process may be easier, the disassembly process is also easy. The assembly could possibly come apart, such as if the vehicle is driven without a spare tire, thereby resulting in loose parts and further preventing an owner from stowing the spare tire at a later date. This would require replacement of the entire spare tire carrier device.

Examples of such prior art can be seen in U.S. Pat. Nos. 3,856,167, 4,429,682 4,613,273, 4,768,361, 5,975,827 and U.S. Patent Application Publication No. 2006/0104769.

### SUMMARY

One aspect of this disclosure provides an end fitting assembly for a chain hoist including: a link insert having a body inserted into a last link of a drive chain of the chain hoist with opposing lateral ends extending therefrom, and a support bracket at least partially surrounding the last link of the drive chain and the opposing lateral ends of the body to secure the body within the last link.

Another aspect of this disclosure provides a chain hoist system for a spare tire carrier in a vehicle including: a housing containing a reel assembly for winding and unwinding a drive chain, the drive chain having a first end mounted to the housing and a second end extending downwardly from the housing; an end fitting assembly on the second end of the drive chain; an attachment device received on the drive chain above the end fitting for support a spare tire; an elastic member between the attachment device and the end fitting. The end fitting assembly includes: a link insert having a body inserted into a last link of a drive chain of the chain hoist with opposing lateral ends extending therefrom, and a support bracket at least partially surrounding the last link of the drive chain and the opposing lateral ends of the body to secure the body within the last link.

Yet another aspect of this disclosure provides a method for assembling an end fitting on a drive chain for a chain hoist, the method including: providing access to a second end of the drive chain extending downwardly from a housing of the chain hoist, a first end of the drive chain configured to be connected to the housing; providing a link insert and a support bracket, the link insert having a body inserted into a last link of a drive chain of the chain hoist with opposing lateral ends extending therefrom and the support bracket at least partially surrounding the last link of the drive chain and the opposing lateral ends of the body to secure the body within the last link, the support bracket having an opening therein configured to receive at least part of the last link on the second end of the drive chain therethrough; inserting at least a last link of the second end of the drive chain through the opening of the support bracket; inserting the body of the link insert at least partially through the last link of the second end of the drive chain; aligning the link insert with the support bracket, and folding at least part of the support bracket at least partially around the link insert, such that the support bracket at least partially surrounds the body of the link insert and the last link of the drive chain.

Other features and advantages of the present disclosure will become apparent from the following detailed description, the accompanying drawings, and the appended claims.

### BRIEF DESCRIPTION OF THE DRAWINGS

FIGS. 1 and 2 illustrate a side and perspective view of a chain hoist assembly for use as a spare tire carrier in a vehicle;

FIG. 3 shows a detailed view of links of a traditional chain for use with a chain reel assembly as disclosed herein.

FIG. 4 shows a plan view of a link insert used in the end fitting assembly of the chain hoist of FIGS. 1 and 2, in accordance with an embodiment.

FIG. 5 shows a plan view of a support bracket used in the end fitting assembly in accordance with an embodiment.

FIG. 6 shows a plan view the link insert and support bracket partially assembled to a drive chain of the chain hoist.

FIG. 7 shows a plan view of the assembled end fitting in accordance with an embodiment.

FIG. 8 shows a plan view of a link insert used in the end fitting assembly of the chain hoist of FIGS. 1 and 2, in accordance with another embodiment.

FIG. 9 shows a plan view of a support bracket used in the end fitting assembly in accordance with another embodiment.

### DETAILED DESCRIPTION

This disclosure proposes an end fitting assembly for use on a chain hoist to support a spare tire when stowed under the vehicle. The end fitting is adapted to fit in and engage with the last closed link on a chain. For example, as noted previously in the background, typical methods may require opening (e.g., cutting) of the last chain link and then welding for securement of the chain link. As described in greater detail later, a support bracket is fitted over the final chain link and a link insert is inserted through the same link. Thus, the quality of the link is not compromised. The support bracket or plate has flanges or wing formations, which are folded or crimped at least partially down over and/or around the link insert, securing it to the chain. Any downward force from the attached tire is transmitted to the link insert.

FIGS. 1 and 2 illustrate a side and perspective view of a chain hoist assembly 10. Chain hoist assembly 10 and its illustrated external parts shown in FIGS. 1 and 2 are exemplary and for reference only. Such illustrations are not intended to be limiting. A hoist, like chain hoist assembly 10, is a device used for lifting or lowering a load by means of a drum or lift-wheel—in this disclosure, called a reel—around which a lifting device wraps and is configured to move therealong. It may be manually operated (e.g., by a set of tools used with a vehicle jack), electrically driven, or fluidly driven (i.e., pneumatically or hydraulically), and thus any type of drive input may be used.

In accordance with an embodiment of this disclosure, chain hoist assembly 10 is used as a tire hoist or winch on a vehicle to secure a spare tire to the vehicle. In accordance with an embodiment, the disclosed stamped reel assembly is set in and used in a hoist assembly provided at an underside of a transportation vehicle (e.g., car, truck, van, SUV, etc.), such as the undercarriage.

Chain hoist assembly 10 houses a chain reel assembly (an example of which is shown in detail in the related and hereby incorporated '958 application) within its housing or shroud 12. Shroud 12 is mounted within the vehicle, such as in an undercarriage. A drive chain 16 is used as the lifting device and to support the weight of the load (e.g., tire). The reel assembly is configured to move a tire between its storage position and extended position via winding and unwinding a drive chain 16 mounted on a reel therein. The drive chain 16 has a first end mounted to or within the housing and a second end for connecting to and/or holding an object thereon. As shown in the FIGS., the second end of the drive chain 16 extends downwardly from the shroud 12 has an end piece 22 (also referred to throughout this disclosure as an end fitting or an end fitting assembly, and described in detail later) thereon. The load (e.g., tire) is attached to the chain hoist assembly by a hook, bracket, or other type of attachment device 18 provided adjacent the second end of the drive chain 16. Attachment device 18 is received on the drive chain 16 above the end piece 22 to support a spare tire. For example, tire can be attached via the middle opening of its rim to attachment device 18. For example, the attachment device 18 is an oblong bracket that the user can fit through the opening in the tire rim by tilting it as the end piece 22 is fed through the opening. Because the oblong slope is longer than the rim opening's diameter, the tire rim will sit on flanges 18′.

Between attachment device 18 and end piece 22 or end fitting is an elastic member 20. Elastic member 20 is mounted between and adjacent to attachment device 18 and is configured for movement between a storage position and an extended position to absorb movement of the tire, e.g., during driving of the vehicle. Rotational movement (e.g., in a clockwise or counterclockwise direction) of the reel assembly and thus the vertical movement of the tire between its positions is generally understood by one of ordinary skill in the art and not provided in great detail herein. Generally, however, it is noted that once rotation is provided to the chain reel assembly (via a drive input), the rotational motion can be transferred to the chain 16 such that the chain will move substantially vertically (up and/or down, as indicated by arrow A), which in turn moves end piece 22 in a vertical direction to tighten and/or collapse elastic member 20. This allows a user to either store or access the spare tire, when needed. Part of the chain (i.e., near or at an end opposite the attachment device) can optionally extend from the shroud, such as generally shown in FIGS. 1 and 2. To access the spare tire, the chain is rotated in an opposite, i.e., counterclockwise, direction via rotation of the chain reel assembly, which advances the outer end of the chain. When the chain is advanced, the end piece 22 moves relative to and away from shroud 12, thereby allowing movement of the tire via the attachment device 18 downwardly and away from the undercarriage, to an extended position, so that it may be accessed and removed therefrom.

The drive chain 16 used with the chain hoist assembly 10 does not require any particular design or configuration of its links (such as flattened zones on its ends or body). Traditional chain links may be used. FIG. 3 shows a detailed view of links of a traditional chain for use as a drive chain 16 with chain hoist assembly 10 as disclosed herein. Drive chain 16 has alternating horizontal links 24 and vertical links 26, as is generally known in the art. For example, each horizontal link 24 is connected to an adjacent vertical link 26 on each side. Each of the links of drive chain 16 comprises a generally oval shape with an opening therein, but it is also envisioned that the drive chain 16 may also be a profile chain or have links that are circular in shape. Each link 24 and 26 has an overall length L, an internal length L2, an overall width W, and an internal width W2 (of the link opening). The link body has a diameter, D, which also corresponds to a chain size. The size of drive chain 16 used with a spare tire carrier is selected from loading criteria from the car manufacturer (customer). The tire mass and vehicle g forces can be considered to determine the chain size. Some examples that can be used are chains with 4.0 mm or 5.0 mm wire diameter.

Referring more specifically now to FIGS. 4 and 5, parts of the end piece 22 or end fitting assembly are shown in greater detail. More specifically, the end fitting assembly comprises a link insert 28 (e.g., see FIG. 4) and a support bracket 30 (e.g., see FIG. 5). Throughout this disclosure, a “link insert” is defined as a structure configured to absorb shear forces transferred from the spare tire to links of chain 16 (e.g., during movement). A “support bracket” is a device configured to brace and support installation of the link insert on the chain 16.

Link insert 28 has a body 32 that is configured to be inserted into a last link 17 on the second end of drive chain 16. More specifically, body 32 is configured to be inserted through and surrounded by last link 17 of chain 16. Body 32 has a height (or width) and thickness that is maximized for receipt within internal length L2 of the link 17. In the illustrated embodiment, last link 17 is a vertical link 26 on the second end of the chain that is configured to receive body 32 substantially horizontally through its center. Body 32 may have at least one detent 34 along its length configured to substantially receive the last link 17 therein. As shown in FIG. 4, a detent 34 is provided in a central portion on both a top and bottom surface of body 32. Detent 34 may include rounded surfaces that are shaped to substantially correspond to receiving the curved end surfaces of link 17. Body 32 also includes arms 36 and 38 with opposing lateral ends extending therefrom. Arms 36 and 38 extend horizontally from the central portion thereof. Each arm 36 and 38 is designed (e.g., with a length, a height or a width, and a thickness) to receive, support, and accommodate the size and/or diameter of the elastic member 20. In an embodiment, the overall length of the link insert 28 (e.g., in horizontal direction, from end-to-end of arms 36 and 38) is based on a size of the elastic member 20 (e.g., a diameter or a width of elastic member 20). During use, reaction forces (due to load forces from the tire) from the elastic member 20 contact the support bracket 30, and subsequently push against the arms 36 and 38 of link insert 28. Arms 36 and 38 thus are constructed and arranged to support this load. Arms 36 and 38 are shaped for fitment within chain link internal length L2, less diameter D, while still maintaining a satisfactory cross-sectional area to withstand the load of the spare tire. The length, height, and/or thickness of the link insert 28 can be adjusted based on the size of the elastic member 20. For example, if a larger diameter spring is used, the length of the arms can be adjusted to properly support the forces from elastic member 20.

Support bracket 30 is configured to at least partially surround the opposing lateral ends of the arms 36 and 38 of link insert 28 and part of the last link 17 of drive chain 16 to secure the body within the last link. Support bracket 30 includes a body 40 with an opening 42 therein configured to receive at least last link 17 therethrough. Also extending from the body are wings 44 and 46. In the illustrated embodiment, wings 44 and 46 are positioned to extend substantially perpendicularly to body 40. However, it should be understood that wings 44 and 46 may also be configured to extend within the same plane as body 40, in a substantially straight, horizontal direction. As further understood by the description below, during assembly, wings 44 and 46 are folded and/or bent to at least partially surround body 32 of link insert 28 to substantially enclose the insert and form end piece 22.

Opening 42 is formed such that link 17 can be inserted through. The opening may be non-circular in shape, polygonal in shape, or any other number of shapes. In one embodiment, opening 42 includes shaped edges for accommodating outer curved surfaces of the link. At least part of the last link 17 on the second end of the drive chain 16 can extend through opening 42 when assembled, as shown in FIGS. 1 and 7, for example. Top curved edges of the link 17 are aligned with and received in the shaped edges of opening 42.

Moreover, in accordance with one embodiment, at least bottom curved surfaces of the adjacent link connected to last link 17, e.g., a horizontal link 24, may be received and aligned in opening 42 as well. That is, opening 42 can also be designed with shaped edges for accommodating at least the horizontal link 24 adjacent to link 17 (26). In an embodiment, the opening 42 has a substantially cross-shaped or “X’-shaped configuration, such as shown in FIG. 5. This shaped opening allows support bracket 30 to slide up around other or additional links of drive chain 16 during end fitting installation and assembly. For example, opening 42 allows for inserting at least two links through at the second end of drive chain 16 before the insertion of link insert 28. In an embodiment, support bracket 30 is configured to at least receive an adjacent or next to last link (e.g., horizontal link 24) at least partially through opening 42 during assembling of the end fitting 22. This allows for access to an opening within last link 17 by providing clearance with regards the extension of wings 44 and 46 from body 40, allowing space to insert link insert 28 into the last link. Further, opening 42 of support bracket 30 aids in preventing rotation of support bracket 30 relative to drive chain 16.

However, this disclosure is not limited to a cross-shaped or X-shaped opening. That is, other shapes may also be used to accommodate movement of chain links through the opening during assembly of the end fitting. For example, a substantially round or oval opening may include edges (further shaped or not) that provide similar clearance and prevent rotation of the support bracket relative to the drive chain.

In an embodiment, body 32 of link insert 28 has a first shape and support bracket 30 has a second shape that substantially corresponds to the first shape of body 32 such that body 32 of the link insert 28 is substantially aligned with support bracket 30. Link insert 28 can be positioned adjacent to support bracket when it is moved towards the insert 28 in the last link. For example, during assembling of the end fitting assembly 22, aligning the link insert with the support bracket including moving the support bracket down to second end of drive chain 16 towards the link insert such that at least second to last link moves (back) through its opening 42. As shown in the illustrated embodiment, at least part of last link 17 is also moved through opening 42 of body 40. In one embodiment, link insert 28 is placed substantially against support bracket 30. For example, as shown in FIG. 5, support bracket 30 may include depressions 48 formed in its body 40 that are configured to substantially receive and align with arms 36 and 38 of link insert 28 on its underside surface upon assembly. Moreover, a width of the bracket may be shaped such that upon alignment with the link insert 28, wings 44 and 46 are positioned adjacent to their outer surfaces. This allows the wings 44 and 46 to then be folded and/or bent to substantially surround the outer edges of arms 36 and 38 (around their opposing lateral ends and sides and substantially thereunder to substantially create “C”-shapes facing inwardly towards one another). Stated differently, the inner surface of the support bracket 30 conforms to the outer surface of body 32.

FIGS. 8 and 9 show alternate embodiments of a link insert 28 and a support bracket 30 of the end piece 22 or end fitting assembly. For purposes of clarity and brevity, like elements and components throughout the Figures are labeled with same designations and numbering as discussed with reference to FIGS. 1-7. Thus, although not discussed entirely in detail herein, one of ordinary skill in the art should understand that various features associated with the parts of FIGS. 8 and 9 are similar to those features previously discussed. Additionally, it should be understood that the features shown in each of the individual figures is not meant to be limited solely to the illustrated embodiments. That is, the features described throughout this disclosure may be interchanged and/or used with other embodiments than those they are shown and/or described with reference to.

Link insert 28 of FIG. 8 has a body 32 that is configured to be inserted into a last link 17 on the second end of drive chain 16. Body 32 may have at least one detent 34 configured to substantially receive the last link 17 therein as well as arms 36 and 38 with opposing lateral ends extending therefrom. Arms 36 and 38 extend horizontally from the central portion thereof. Support bracket 30 of FIG. 9 is configured to at least partially surround the opposing lateral ends of the arms 36 and 38 of link insert 28 shown in FIG. 8 and part of the last link 17 of drive chain 16 to secure the body within the last link. Support bracket 30 includes a body 40 with an opening 42 therein configured to receive at least last link 17 therethrough. During assembly, wings 44 and 46 in FIG. 9 are folded and/or bent to at least partially surround body 32 of link insert 28 of FIG. 8 to substantially enclose the insert and form end piece 22, in a similar fashion as previously described. As shown in FIG. 9, support bracket 30 may include depressions 48 formed in its body 40 that are configured to substantially receive and align with arms 36 and 38 of link insert 28 of FIG. 8 on its underside surface upon assembly.

In accordance with an embodiment, the shape of the body of link insert 28 and/or support bracket 30 used in the end fitting assembly is designed to accommodate the size of the chain link used with the assembly. Different sized links may require adjustments to the size/shape of the link insert 28 and/or the bracket 30. In accordance with an embodiment, a width and a thickness of body 32 can be altered and/or maximized for receipt within internal length L2 of the link 17 to provide as much cross section as possible to strengthen the link insert 28 for withstanding receipt of high shear forces, since the forces in the assembly are transferred to the link insert 28. Link insert 28 can be stronger than the chain 16.

Modifications for other settings can include increasing or decreasing material thickness to accommodate different chain sizes and load requirements. The chain link diameter may be selected based on chain sizes available per spare tire loading conditions, and the corresponding dimensions thereof (as shown, for example, in FIG. 3). Chain link internal width W2 can determine a link insert material thickness. Chain link internal length L2 may dictate the height or the width of the link insert. In an embodiment, because the support bracket is in compression when loaded with the spare tire, a thinner material may be chosen for its manufacture. The overall size (e.g., length) of the body 32 and/or detents 34 of link insert 28 and/or opening 42, wings 44 and 46, and depressions 48 of support bracket 30 can also be scaled for different sizes of chain links and/or mating components (e.g., compensation spring, link insert, etc.).

In an embodiment, the overall length of the link insert 28 can range inclusively from approximately 20 mm to inclusively approximately 40 mm. In an embodiment, a height or width of the link insert 28 can range inclusively approximately from 7 mm to inclusively approximately 14 mm. In an embodiment, a thickness of link insert 28 can range inclusively from approximately 5 mm to inclusively approximately 7 mm. In one embodiment, the thickness of link insert 28 is approximately 6.0 mm.

However, any dimensions disclosed herein are not meant to be limiting.

FIGS. 6 and 7 show in greater detail an example of link insert 28 and support bracket 30 partially assembled and fully assembled, respectively, when attached to drive chain 16 of chain hoist 10 in accordance with an embodiment. Accordingly, it is in accordance with an embodiment of this disclosure to provide a method for assembling an end fitting on a drive chain for a chain hoist, the method including: providing access to a second end of the drive chain 16, a first end of the drive chain configured to be connected to a housing 12 of the chain hoist 10; providing a link insert 28 and a support bracket 30, the link insert 28 having a body 32 that is configured to be connected with a last link 17 on the second end of the drive chain 16 and the support bracket 30 configured to at least partially surround the body 32 of link insert 28, the support bracket 30 having an opening 42 therein configured to receive at least part of the last link 17 on the second end of the drive chain therethrough. To assemble, the method can include inserting at least the last link 17 of the second end of the drive chain 16 through the opening 42 of the support bracket 30. The method may further include moving the support bracket 28 along the chain such that at least the next to last link (i.e., horizontal link 24) connected to the last link 17 is further inserted at least partially through the opening 42 to provide clearance with regards to wings 44 and 46 and allow access to last link 17 for insertion of link insert 28. Once the bracket 30 is moved along the chain and access is provided to the opening of last link 17, installation and assembly can proceed by inserting the body 32 of the link insert 28 at least partially through the last link 17 of the second end of the drive chain (e.g., so that it substantially aligns within detents 34 therein). Then, the link insert 28 is substantially aligned with the support bracket 30 (e.g., within depressions 48) such their surfaces are adjacent to (and in some instances, substantially against) each other. As shown by the arrows B and C in FIG. 6, the method then includes folding at least part of the support bracket (e.g., wings 44 and 46) at least partially around the link insert 28, such that the support bracket at least partially surrounds the body of the link insert and the last link of the drive chain, as shown in FIG. 7.

To manufacture link insert 28 and support bracket 30 of end piece 22 as disclosed herein, any number or combination of processes may be used. For example, link insert 28 and/or support bracket 30 may be formed through a stamping process. In an embodiment, a blanking process can be used. For example, link insert 28 could be made using a fine blanking process.

Link insert 28 and support bracket 30 can be made from any number or combination of materials. In one embodiment, link insert 28 is made from HSLA (High Strength Low Alloy). However, link insert 28 may be formed from any material(s) that are capable of withstanding shear forces and loads. In one embodiment, support bracket 30 is made from low carbon steel. However, support bracket 30, which is in compression, need not be made from any particular material.

Accordingly, the parts can be assembled to and/or used as part of chain hoist 10 for a spare tire carrier (winch assembly) that uses a chain to support the tire, e.g., instead of a cable or wire rope. For example, as described above with reference to FIGS. 1 and 2, the end fitting assembly 22 can be attached to a last link of the second end of drive chain 16. Tire load and/or storage forces are transferred from the drive chain 16 to the end fitting assembly 22.

Accordingly, as described throughout, the herein disclosed end fitting assembly provides several improvements over the prior art. None of the chain links need modifications or processing (e.g., opening, cutting, welding) after receipt from the chain supplier (for their connection to the chain links) which could affect their mechanical properties. Rather, the design of this chain link end fitting assembly maintains the structural integrity of at least the last chain link. The assembly is designed to withstand forces from the spare tire. In some cases, it is stronger than the chain. Furthermore, the parts are easy to assemble. Moreover, once assembled, they cannot be easily (or accidentally) disassembled. The support bracket wings or flanges are formed to prevent accidental disassembly (e.g., such as when driving without a stowed spare tire.)

While the principles of the disclosure have been made clear in the illustrative embodiments set forth above, it will be apparent to those skilled in the art that various modifications may be made to the structure, arrangement, proportion, elements, materials, and components used in the practice of the disclosure.

It will be appreciated that several of the above-disclosed and other features and functions, or alternatives thereof, may be desirably combined into many other different systems/devices or applications. Various presently unforeseen or unanticipated alternatives, modifications, variations, or improvements therein may be subsequently made by those skilled in the art which are also intended to be encompassed by the following claims.

What is claimed is:

1. An end fitting assembly for a chain hoist comprising:
a link insert comprising a body inserted into a last link of a drive chain of the chain hoist with opposing lateral ends extending therefrom, and
a support bracket at least partially surrounding the last link of the drive chain and the opposing lateral ends of the body to secure the body within the last link.

2. The end fitting assembly according to claim 1, wherein the body of link insert comprises at least one detent configured to substantially receive the last link therein.

3. The end fitting assembly according to claim 2, wherein the support bracket comprises an opening therein in which at least part of the last link on the second end of the drive chain extends therethrough.

4. The end fitting assembly according to claim 1, wherein the support bracket comprises an opening therein in which at least part of the last link on the second end of the drive chain extends therethrough.

5. The end fitting assembly according to claim 4, wherein the opening of the support bracket has a shape substantially in the form of a cross or “X” configured to allow at least an adjacent link connected to the last link to extend through opening during its installation and to prevent rotation of the support bracket relative to the drive chain.

6. The end fitting assembly according to claim 1, wherein the body of the link insert comprises a first shape and wherein the support bracket comprises a second shape that corresponds to the first shape of the body of the link insert such that the body of the link insert is substantially aligned with and substantially against the support bracket.

7. A chain hoist system for a spare tire carrier in a vehicle comprising:
a housing containing a reel assembly for winding and unwinding a drive chain, the drive chain comprising a first end mounted to the housing and a second end extending downwardly from the housing;
an end fitting assembly on the second end of the drive chain;
an attachment device received on the drive chain above the end fitting for supporting a spare tire;
an elastic member between the attachment device and the end fitting;
the end fitting assembly comprising:
a link insert comprising a body inserted into a last link of a drive chain of the chain hoist with opposing lateral ends extending therefrom, and
a support bracket at least partially surrounding the last link of the drive chain and the opposing lateral ends of the body to secure the body within the last link.

8. The chain hoist assembly according to claim 7, wherein the last link is substantially aligned within at least one detent in the body of link insert.

9. The chain hoist system according to claim 8, wherein the support bracket comprises an opening therein in which at least part of the last link on the second end of the drive chain extends therethrough.

10. The chain hoist system according to claim 7, wherein the support bracket comprises an opening therein in which at least part of the last link on the second end of the drive chain extends therethrough.

11. The end fitting assembly according to claim 7, wherein the opening of the support bracket has a shape substantially in the form of a cross or “X” configured to allow at least an adjacent link connected to the last link to extend through opening during its installation and to prevent rotation of the support bracket relative to the drive chain.

12. The chain hoist system according to claim 7, wherein the body of the link insert comprises a first shape and wherein the support bracket comprises a second shape that corresponds to the first shape of the body of the link insert such that the body of the link insert is substantially aligned with and substantially against the support bracket.

13. A method for assembling an end fitting on a drive chain for a chain hoist, the method comprising:
providing access to a second end of the drive chain extending downwardly from a housing of the chain hoist, a first end of the drive chain configured to be connected to the housing;
providing a link insert and a support bracket, the link insert comprising a body inserted into a last link of a drive chain of the chain hoist with opposing lateral ends extending therefrom and the support bracket at least partially surrounding the last link of the drive chain and the opposing lateral ends of the body to secure the body within the last link, the support bracket having an opening therein configured to receive at least part of the last link on the second end of the drive chain therethrough;
inserting at least a last link of the second end of the drive chain through the opening of the support bracket;
inserting the body of the link insert at least partially through the last link of the second end of the drive chain;
substantially aligning the link insert with the support bracket, and
folding at least part of the support bracket at least partially around the link insert, such that the support bracket at least partially surrounds the body of the link insert and the last link of the drive chain.

14. The method according to claim 13, wherein the link insert comprises at least one detent in its body, and wherein the method further comprises aligning the last link substantially within at least one detent of the body of the link insert.

15. The method according to claim 13, wherein the opening of the support bracket has a shape substantially in the form of a cross or “X” configured to allow at least an adjacent link connected to the last link to extend through opening during its installation and to prevent rotation of the support bracket relative to the drive chain, and wherein the method further comprises inserting at least two links at the second end of the drive chain through the opening of the support bracket before the inserting of the link insert, and wherein the aligning the link insert with the support bracket comprises moving the support bracket towards the link insert such that a second to last link moves through its opening.

16. The method according to claim 13, wherein the body of the link insert comprises a first shape and wherein the support bracket comprises a second shape that corresponds to the first shape of the body of the link insert such that the substantially aligning comprises placing the link insert substantially against the support bracket.
